(19) United States
(12) Patent Application Publication
(10) Pub. No.: US 2007/0194075 A1
(43) Pub. Date: Aug. 23, 2007

(54) Combustion gas type nailing machine

(76) Inventors: Hiroshi Tanaka, Tokyo (JP); Michiaki Adachi, Tokyo (JP)

Correspondence Address: MORGAN LEWIS & BOCKIUS LLP, 1111 PENNSYLVANIA AVENUE NW, WASHINGTON, DC, 20004, US

(21) Appl. No.: 10/592,129

(22) PCT Filed: Mar. 9, 2005
(86) PCT No.: PCT/JP05/04091

§ 371 Date: Sep. 8, 2006

(30) Foreign Application Priority Data
Mar. 12, 2004 (JP) 2004-070071

(51) Int. Cl. B25C 1/04

(52) U.S. Cl. 227/8; 227/130

(57) ABSTRACT

A combustion gas type nailing machine includes a lock-out bar 31 of which one end is coupled to a movable sleeve 12; a cam member 32 which is provided opposed to the other end of the lock-out bar 31 and cooperates with a trigger unit 27 rotatably; a cam surface 34 which is formed on the cam member 32, and comes into contact with the lower end of the lock-out bar 31 thereby to retain the movable sleeve 12 in a state where a combustion chamber 6 is closed; and a step portion 44 which is formed on the cam surface 34 and can engage with the lock-out bar 31. When the cam surface 34 retains the movable sleeve 12, the step portion 44 engages with the lock-out bar 31 to interrupt the rotational movement of the cam member 32, whereby it is prevented that the trigger unit 27 is operated to a position where the trigger 27 mechanism ignites the inflammable gas.

### TECHNICAL FIELD

The present invention relates to a combustion gas type nailing machine which drives a piston under pressure power of combustion gas generated by combusting inflammable gas, and drives a nail or a pin into a work such as a concrete or a timber by a driver integrally coupled to the piston.

### BACKGROUND ART

There is known a combustion gas type nailing machine, in which inflammable gas is injected into a tightly closed combustion chamber thereby to generate mixed gas of the inflammable gas and air, the mixed gas is fired and burned to generate high combustion gas pressure in the combustion chamber, a piston slidably accommodated in a cylinder is impactively driven by the gas pressure, and a nail is driven into a steel plate or a concrete by a driver coupled with the piston. In such the combustion gas type nailing machine, a nose having a discharge port for guiding a nail toward a work is coupled to a lower portion of a housing in which a cylinder is housed, and the driver coupled with the piston is housed and guided in the discharge port. On the back side of the nose, a magazine is mounted and many nails are housed in the magazine. The nail supplied from the magazine to the discharge port of the nose is driven by the driver from the discharge port into the work positioned at the leading end of the nose.

In the power-driven nailing machine which is driven by the combustion gas, a contact member slidably supported along the discharge port is provided on a peripheral surface of the nose forming the discharge port. The upper end of the contact member is interlocked with a movable sleeve forming the combustion chamber through a guide rod. When the contact member is operated upward, the movable sleeve is moved upward and the combustion chamber is closed tightly. Thereafter, the inflammable gas is inleted into the combustion chamber to generate the mixed gas in the combustion chamber. Next, a trigger provided so that it can be operated by user's hand holding the nailing machine is operated, whereby the mixed gas in the combustion chamber is ignited and the nailing machine is actuated. Thus, the contact member constitutes a safety mechanism which operates so that the tool cannot start before the discharge port of the nailing machine is brought into contact with the work and the contact member is operated.

In the above combustion gas type nailing machine, the piston is driven to a bottom dead center in the cylinder by the combustion gas generated by combusting the inflammable gas in the combustion chamber, and the pin is driven by the driver integrally coupled to the piston. In the time, a part of the combustion gas which has operated the piston is discharged to the outside of the cylinder through an opening provided in a wall surface of the cylinder and an one way valve, and the combustion gas remaining in the cylinder is cooled, whereby the volume of the combustion gas decreases, a negative pressure is generated on the upper surface side of the piston, and the piston is raised and returned to a top dead center by the negative pressure. In case of such the construction that the movable sleeve forming the combustion chamber is coupled to the contact member and operated by the contact member, when the nailing machine operates upward by a reaction produced in the drive of the piston, and the contact member performs a return operation, there is possibility that the movable sleeve forming the combustion chamber operates with the return operation and the combustion chamber is opened. If the combustion chamber is opened while the piston is restored to the top dead center by the negative pressure, the negative pressure is released and the piston can not return to the top dead center.

In order to prevent that the piston cannot be thus restored due to the return of the contact member, the related art adopting the following mechanism has been known (for example, JP-B-04-011337). In the mechanism, the movable sleeve that has been moved upward by operating the contact member is retained in the upward position by the operation of a trigger for turning on a switch for applying electric current to a spark plug, which is operated after the operation of the contact member, and the movable sleeve is retained so as not to operate in the direction where the movable sleeve opens the combustion chamber as long as the trigger is operated. In the related art, an U-shaped lock-out bar is coupled to the movable sleeve forming the combustion chamber, a lower end portion of the lock-out bar is arranged opposed to a cam which is rotated and driven in cooperation with the operation of the trigger, and the cam rotated by operating the trigger is allowed to come below the lock-out bar operated upward integrally with the movable sleeve, whereby the movable sleeve is retained by the cam in the state where the combustion chamber is closed. Hereby, as long as the trigger is operated, the movable sleeve can be retained in the position where the combustion chamber is closed. Therefore, even if the nailing machine operates upward by the reaction to nail-driving and the contact member is returned, the combustion chamber is surely closed, so that the returning operation of the piston to the top dead center is surely performed.

The above conventional trigger turns on the switch for applying the electric current to the spark plug at the last portion of the operation stroke of the trigger, and rotates the cam at the initial portion of the operation stroke of the trigger to retain the movable sleeve in the state where the combustion chamber is closed. Therefore, after the contact member has been pressed to the work and operated, and the movable sleeve has been operated upward, the trigger is operated to the midway portion of the operation stroke thereof, whereby the combustion is retained in the closed state. Thereafter, even if the nose portion and the contact member are separated from the work, the state where the combustion chamber is closed is kept. Thereafter, the trigger is operated to the last of the operation stroke thereof, whereby discharge current is allowed to flow in the spark plug.

Thus, in the related art, after the combustion chamber has been closed by operating the contact member, and the state has been retained by operating the trigger, by separating the nose portion of the nailing machine from the work and operating the trigger more, the switch for applying the electric current to the spark plug is turned on, and the mixed gas in the combustion chamber is ignited and burned. In case that nail-driving is thus performed in the state where the nose portion is apart from the work, there is the danger that the nail is driven in a state where the nailhead comes out from the surface of the work, or that the nail is driven in a state where the nail-driving direction tilts in relation to the surface of the work, thereby to cause spring-out of the nail.

### DISCLOSURE OF THE INVENTION

### Problem to be Solved by the Invention

It is an object of the invention to provide a combustion gas type nailing machine, which can perform a return operation to a top dead center position of a piston driven by combustion gas without hindrance, and sets a trigger mechanism so that it cannot operate to a position where it ignites the combustion gas in a combustion chamber when a nose portion and a contact member are separated from a work.

### MEANS TO SOLVE THE PROBLEM

In order to attain the object, an embodiment of the invention provides a combustion gas type nailing machine including a cylinder arranged in a housing; a piston which is slidably housed in the cylinder and has on its one end side a driver for driving a nail; a nose portion which is attached to one end side of the housing and has a discharge port for guiding the driver slidably; a combustion chamber formed above the cylinder in the housing by a movable sleeve provided slidably up and down; a manually operatable trigger unit which ignites inflammable gas generated in the combustion chamber; and a contact member which is arranged protrusively in the leading end direction of the nose portion, and engages with a work thereby to operate the movable sleeve and close tightly the combustion chamber. The combustion gas type nailing machine drives the piston by combustion gas generated by burning the inflammable gas in the tightly closed combustion chamber and drives a nail. The combustion gas type nailing machine further includes a lock-out bar of which one end is coupled to the movable sleeve; a cam member which is provided opposed to the other end of the lock-out bar and cooperates with the trigger unit rotatably; a cam surface which is formed on the cam member, and comes into contact with the lower end of the lock-out bar thereby to retain the movable sleeve in a state where the combustion chamber is closed; and a step portion which is formed on the cam surface and can engage with the lock-out bar. Herein, when the cam surface holds the movable sleeve, the step portion engages with the lock-out bar and interrupts the rotational movement of the cam member, whereby it is prevented that the trigger unit is operated to a position where the trigger unit ignites the inflammable gas.

Further, the trigger unit includes an operating part formed at the cam member, and an operational part which is coupled through an elastic member to the operating part and manually operated. The operating part has a projection part which operates a switch for igniting the inflammable gas generated in the combustion chamber.

### BRIEF DESCRIPTION OF THE DRAWINGS

FIG. 1 is a longitudinal sectional view showing a combustion gas type nailing machine in which an actuator of an embodiment of the invention is applied.

FIG. 2 is a sectional view taken along a line II-II in FIG. 1.

FIG. 3 is an exploded perspective view of main members constituting the actuator of the same combustion gas type nailing machine as that in FIG. 1.

FIG. 4 is a longitudinal sectional view showing a working state of the same actuator as that in FIG. 1 before the actuator is operated.

FIG. 5 is a longitudinal sectional view of the actuator, which shows a working state where a contact member is pressed onto a work.

FIG. 6 is a longitudinal sectional view of the actuator, which shows a working state where gas in a combustion chamber is ignited by operating a trigger unit.

FIG. 7 is a longitudinal sectional view of the actuator, which shows a working state where a movable sleeve is retained in a state where the combustion chamber is tightly closed.

FIG. 8 is a longitudinal sectional view of the actuator, which shows a working state where the actuator is further operated more from the state shown in FIG. 7.

### DESCRIPTION OF REFERENCE NUMERALS

In the drawings, a reference numeral 1 is a combustion gas type nailing machine, 6 is a combustion chamber, 12 is a movable sleeve, 16 is a contact member, 27 is a trigger unit, 31 is a lock-out bar, 32 is a cam member, 34 is a cam surface, is an operational part, 37 is an operating part, and 44 is a step portion.

### BEST MODE FOR CARRYING OUT THE INVENTION

With reference to the drawings, embodiments of the invention will be described.

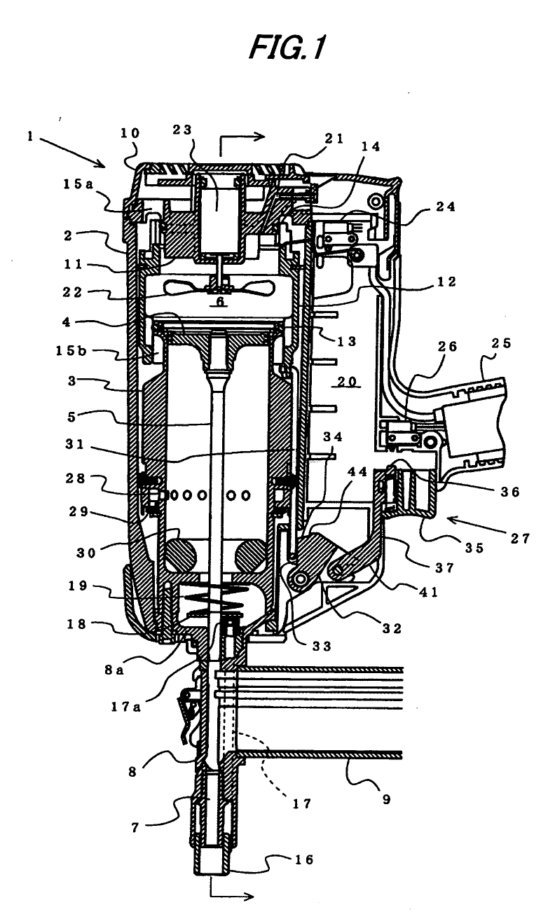

The drawings show one example of the combustion gas type nailing machine of the invention. As shown in FIG. 1, in a combustion gas type nailing machine 1, a cylinder 3 in which a piston 4 is slidably housed is housed in a housing 2, and a driver 5 for driving a nail is integrally coupled to a lower surface side of the piston 4. At an upper end of the cylinder 3 where the upper surface of the piston 4 is exposed, a combustion chamber 6 is formed, and the piston 4 is impactively driven in the cylinder 3 by pressure of combustion gas generated by burning inflammable gas in the combustion chamber 6. To a lower portion of the housing 3, a nose portion 8 having a discharge port 7 for guiding a nail toward a work to be nailed is attached, and the driver 5 coupled to the piston 4 is slidably guided and housed in the discharge port 7. On a back side of the nose portion 8, a magazine 9 in which many nails are housed is provided. The nails loaded in the magazine 9 are supplied to an inside of the discharge port 7 of the nose portion 8 in order, and are driven by the driver 5 from the discharge port 7 into the work in order.

The combustion chamber 6 is formed by an upper end portion of the cylinder 3, a partition wall 11 formed on an upper housing 10 side, and a movable sleeve 12 arranged between the upper end of the cylinder 3 and the partition wall 11. The movable sleeve 12 is slidable between an up-position in which the combustion chamber 6 is put in a tightly closed state and a down-position in which the inside of the combustion chamber 6 is released into the air. The lower portion of the movable sleeve 12 positioned on the up-position is fitted into an O-ring 13 attached to an upper end peripheral surface of the cylinder 3 and the upper portion of the movable sleeve 12 is fitted into an O-ring 14 attached to the partition wall 11 formed in the upper housing 10, whereby the tightly closed combustion chamber 6 is formed. When the movable sleeve 12 operates downward, the upper and lower portions of the movable sleeve 12 are detached from the both O-rings 13, 14, whereby the inside of the combustion chamber 6 is communicated with the air through vents 15a, 15b.

At a leading end of the nose portion 8, a contact member 16 protruding in the leading end direction of the nose portion 8 so that it can come into contact with the driven member when the nose portion 8 is pressed on the work is arranged so that it can slide along the nose portion 8. The contact member 16 includes a guide rod 17, of which one end is secured to the peripheral surface of the contact member 16, and the other extends straight upward. By the guide rod 17, the contact member 16 is supported slidably in relation to the nose portion 8, and the straight upward extending end of the guide rod 17 operating up and down integrally with the contact member 16 penetrates a flange part 8a formed at the upper end portion of the nose portion 8 and is arranged below the cylinder 3 in the housing 2.

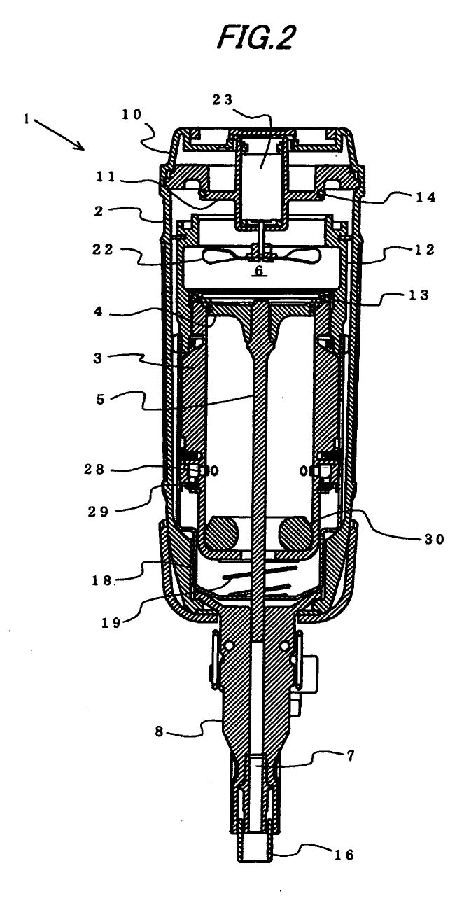

As shown in FIG. 2, a link member 18 is arranged in a space between the inner surface of the housing 2 and the outer surface of the cylinder 3, and an upper end portion of the link member 18 is coupled to a lower end portion of the movable sleeve 12. By sliding the link member 18 in the up-and-down direction, the movable sleeve 12 is slid in the up-and-down direction and operated between the up-position in which the inside of the combustion chamber 6 is disconnected from the vents 15a, 15b and the down-position in which the inside of the combustion chamber 6 is communicated with the vents 15a, 15b. The lower end portion of the link member 18 is arranged at the lower portion of the cylinder 3 and above the nose portion 8, and a spring 19 arranged between the lower surface of the cylinder 3 and the lower end portion of the link member 18 urges the link member 18 downward, whereby the movable sleeve 12 is arranged in the down-position in which the inside of the combustion chamber 6 is communicated with the vents 15a, 15b.

An operation end 17a is formed at the upper end arranged in the housing 2, of the guide rod 17 coupled to the contact member 16, and the operation end 17a is arranged so as to be opposed to the downside of the lower end portion of the link member 18 coupled to the movable sleeve 12. By pressing the leading end of the discharge port 7 of the nose portion 8 on the work, the contact member 16 protruded in the leading end direction of the nose portion 8 comes into contact with the work and slid, whereby the guide rod 17 is slid upward along the discharge port 7 of the nose portion 8, the operation end 17a of the guide rod 17 operates the link member 18 upward against the energizing force of the spring 19, and the movable sleeve 12 is operated to the up-position in which the combustion chamber 6 inside is disconnected from the vents 15a, 15b.

In the housing 2, a housing part 20 which houses a gas container in which inflammable gas is sealed is formed. Further, in the upper housing 10, a supply path 21 which communicates the housing part 20 and the combustion chamber 6 is formed. The gas container filled with the inflammable gas is housed in the housing part 20 in a state where a jet nozzle of the gas container is connected to an end of the supply path 21. The gas container housed in the housing part 20 in the state, when the movable sleeve 12 is operated upward by the contact member 16 and the combustion chamber 6 is closed, tilts the upper portion of the gas container in the direction of the supply path 21 by the upward movement of the movable sleeve 12, and jets the inflammable gas through the supply path 21 into the tightly closed combustion chamber 6. Further, in the gas container, a measuring valve (metering valve) is formed. After the combustion chamber 6 has been closed, the gas container is tilted, whereby a predetermined amount of inflammable gas is jetted into the combustion chamber 6.

Further, in the combustion chamber 6, a rotary fan 22 is arranged, which stirs the inflammable gas injected into the combustion chamber 6 and air in the combustion chamber 6 to generate mixed gas in the combustion chamber 6. The rotary fan 22 is rotated by an electric motor 23 housed in the upper housing 10. When the movable sleeve 12 is operated upward by the operation of the contact member 16 and the combustion chamber 6 is closed, a switch 24 is turned on. On the basis of the switch signal, the electric motor 23 is driven while the combustion chamber 6 is closed and for a predetermined time after the combustion chamber 6 was opened, thereby to rotate the rotary fan 22. By the rotary fan 22, the mixed gas of the inflammable gas jetted into the combustion chamber 6 and the air in the combustion chamber 6 is generated. Further, in the state where the combustion chamber 6 after the piston 4 has been driven is communicated with the vents 15a and 15b, the combustion gas is discharged to the outside of the combustion chamber 6 and simultaneously fresh air is taken into the combustion chamber 6.

Inside a base portion of a grip part 25 formed integrally with the housing 2, a switch 26 for applying electric current to a spark plug (not shown) which ignites the mixed gas in the combustion chamber 6 is arranged, and a trigger unit 27 is formed on the lower side of the base portion of the grip part 25, opposed to the switch 26. By operating the trigger unit 27, the switch 26 is turned on/off thereby to ignite the mixed gas generated in the combustion chamber 6, and the piston 4 in the cylinder 3 is operated by the high-pressure combustion gas generated when the mixed gas burns in the combustion chamber 6, whereby the nail is shot out from the discharge port 7 by the driver 5 coupled to the piston 4.

In the peripheral wall near the lower portion of the cylinder 3, an opening 28 communicated to the air is provided, and a check valve 29 which allows gas to flow from the inside of the cylinder 3 in only the direction of the air is provided between the opening 28 and the air. When the combustion gas that has expanded by burning in the combustion chamber 6 drives the piston 4, and the piston 4 operates to the position near the bottom dead center where the piston 4 is brought into contact with a bumper 30 arranged at the lower portion in the cylinder 3, the opening 28 is opened on the upside of the piston 4 and a part of the combustion gas which is driving the piston 4 is released through the opening 28 and the check valve 29 to the air. Thereafter, the combustion gas that has expanded is rapidly cooled, whereby the volume of the gas is reduced and a negative pressure is generated on the upside of the piston 4 in the cylinder 3. By the negative pressure, the piston that has been driven to the bottom dead center is raised and restored to the top dead center in the cylinder 3.

To the lower end portion of the movable sleeve 12, one end of a lock-out bar 31 formed by bending a metal rod in the U-shape is coupled, and the lock-out bar 31 can operate in the up-and-down direction integrally with the operation in the up-and-down direction of the movable sleeve 12. The other end portion of the lock-out bar 31 is arranged downward along the peripheral surface of the cylinder 3, and a cam member 32 is provided rotatably so as to be opposed to the end portion of the lock-out bar 31. The cam member 32 has a stop surface 33 which engages with the side surface of the lock-out bar 31 and interrupts the rotation of the cam member 32 when the lock-out bar is arranged in the down-position, and a cam surface 34 which is arranged below the lock-out bar 31 by the rotation of the cam member 32 when the lock-out bar 31 operates upward, and engages with the lower end portion of the lock-out bar 31 thereby to interrupt the descent of the lock-out bar 31.

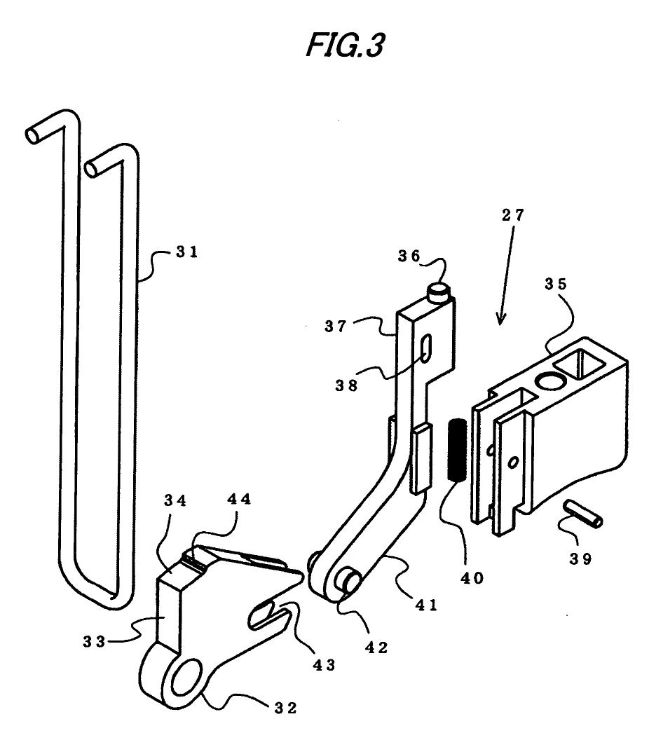

The trigger unit 27, as shown in FIGS. 1 and 3, consists of an operational part 35 which is provided for the housing 2 slidably in the up-and-down direction so that it can be operated by a finger of a hand gripping a grip part 25, and an operating part 37 having at its upper end a projection part 36 which operates the switch 26. Into a long hole 38 provided in the operating part 37, a guide pin 38 attached to the operational part 35 is fitted loosely, whereby the operating part 37 and the operational part 35 are supported by each other slidably in the up-and-down direction, and they are always slide-energized upward by an elastic member 40 arranged between the operational part 35 and the operating part 37. By operating the operational part 35, the operating part 37 is operated upward through elastic force of the elastic member 40, and at the last portion of the operation stroke of the operational part 35, the projection part 36 formed on the operating part 37 turns on the switch 26.

At the operating part 37 constituting the trigger unit 27, an arm part 41 extending downward is formed integrally, and the end portion of the arm part 41 is arranged in the direction of the cam member 32 arranged below the lock-out bar 31. A convex part 42 protruded from both side surfaces of the arm part 41 is formed at the end portion of the arm part 41, and a recess 43 for housing the convex part 42 formed at the arm part 41 of the operating part 37 is formed on one end side of the cam member 32. The operating part 37 and the cam member 32 are operation-coupled to each other so as to be operated in such association with each other that the cam member 32 is rotated with the up-and-down sliding operation of the operating part 37 by loosely fitting the convex part 42 of the operating part 37 into the recess 43 of the cam member 32.

The stop surface 33 formed on the cam member 32 is opposed to the side surface of the lower end portion of the lock-out bar 31 arranged together with the movable sleeve 12 in the down-position when the movable sleeve 12 is arranged in the down-position where the combustion chamber 6 is not closed. The stop surface 33 interrupts the rotation of the cam member 32 in the state, thereby to prevent the operation of the trigger unit 27 under the state where the combustion chamber 6 is not closed, that is, thereby to prevent the switch 26 for applying the electric current to the spark plug from being turned on.

Further, the cam surface 34 of the cam member 32, when the movable sleeve 12 is operated upward by the operation of the contact member 16, and thereafter the cam member 32 operation-coupled to the trigger unit 27 is rotated by the operation of the trigger unit 27, comes under the lock-out bar 31 moving upward together with the movable sleeve 12, and interrupts the descent of the lock-out bar 31 and the movable sleeve 12. For example, also when the housing 2 whole comes up by reaction to the nail-driving, resultantly the discharge port 7 and the contact member 16 relatively move, and the contact member 16 operates in the return direction, the cam surface 34 engages with the lower end of the lock-out bar 31, whereby the movable sleeve 12 forming the combustion chamber 6 is retained in the up-position where the combustion chamber 6 is tightly closed. Therefore, it is possible to prevent the combustion chamber 6 from being opened while the piston 4 operated by the combustion gas is restored to the top dead position.

Further, on the cam surface 34 of the cam member 32, a step portion 44 is formed, which is engaged with the lock-out bar 31 so as to prevent the cam member 32 from being rotated more through the trigger unit 27 in the state where the movable sleeve 12 is retained by the cam surface 34 through the lock-out bar 31 in the up-position where the combustion chamber 6 is tightly closed. The step portion 44 is formed with such height that the lower end portion of the lock-out bar 31 does not engage with the step portion 44 when the movable sleeve 12 is operated to the top dead center position through the contact member 16 and the lock-out bar 31 is thereby arranged in the topmost position. Therefore, till the contact member 16 is pressed on the work and the movable sleeve 12 is operated to the top dead center position, the trigger unit 27 cannot be operated to the position where the switch 26 for applying the electric current to the spark plug is turned on, whereby it is prevented that nail-driving is performed under a state where the nose portion 8 or the contact member 16 is apart from the work.

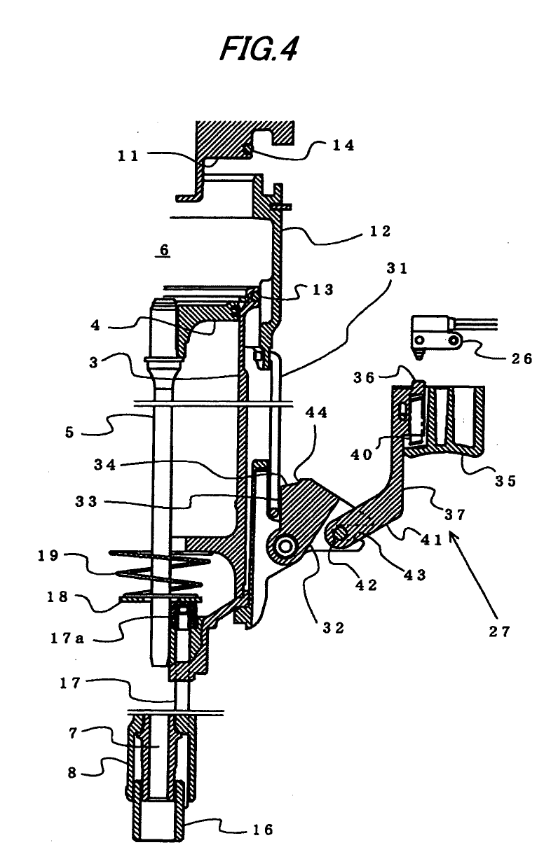

Referring to FIGS. 4 to 8, the operating state of an actuator in the above embodiment will be described below. In an initial state shown in FIG. 4, the link member 18 is pressed downward through the spring 19 and the movable sleeve 12 is arranged in the down-position where the inside of the combustion chamber 6 is communicated with the air. Further, the contact member 16 is pressed through the guide rod 17 by the link member 18 and protruded in the leading end direction of the nose portion 8. The lower end portion of the lock-out bar 31 coupled to the movable sleeve 12 is arranged in the position where the lower end portion faces onto the stop surface 33 of the cam member 32, whereby the rotation of the cam member 32 is interrupted, and the trigger unit 27 cannot be operated.

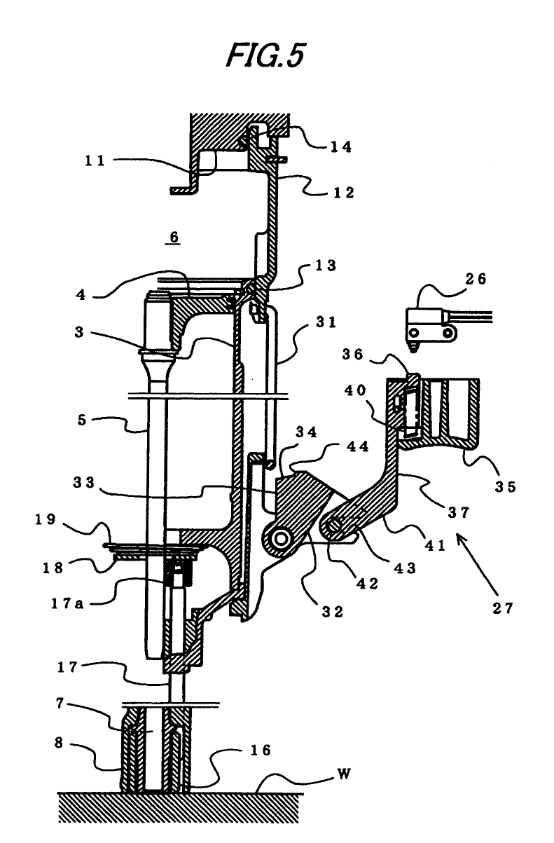

As the leading end of the discharge port 7 of the nose portion 8 is pressed on the work W in order to actuate the nailing machine 1, as shown in FIG. 5, the contact member 16 engages with the work W and is slid along the nose portion 8. Hereby, the operation end 17a formed at the leading end of the guide rod 17 engages with the link member 18, and the movable sleeve 12 is operated to the up-position through the link member 18, so that the movable sleeve 12 is fitted into the two O-rings 13 and 14 and the tightly closed combustion chamber 6 is formed. As the movable sleeve 12 operates upward, the rotary fan 22 is rotated and the predetermined amount of inflammable gas is jetted into the combustion chamber 6, so that the inflammable gas and air are stirred in the combustion chamber 6 and the mixed gas is generated. In the state where the nose portion 8 and the contact member 16 are pressed on the work W, the movable sleeve 12 is operated to the top dead center position, and the lock-out bar 31 coupled to the movable sleeve 12 is operated to the top dead center position where the lower end portion of the lock-out bar 31 does not engage with the step portion 44 formed on the cam surface 34 of the cam member 32.

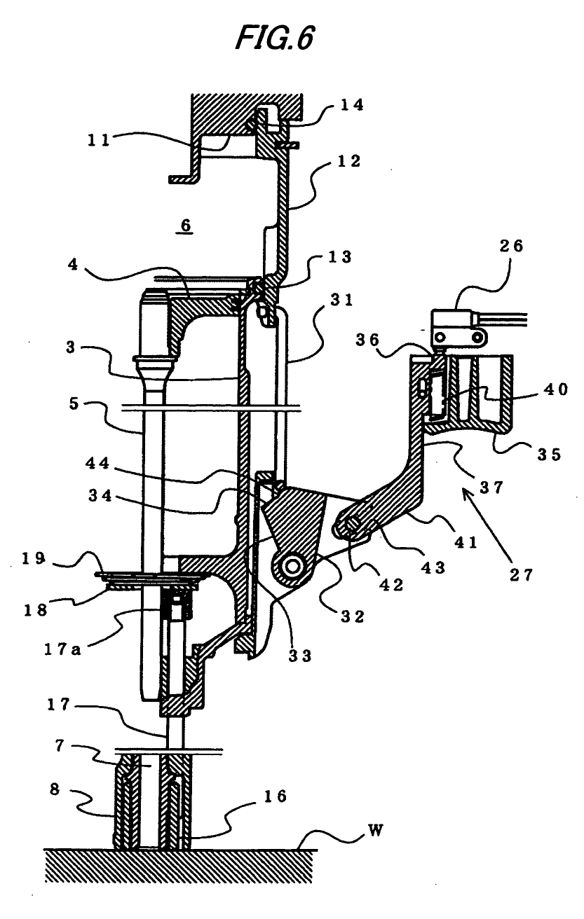

When the operational part 35 of the trigger unit 27 is slid upward as shown in FIG. 6, the operating part 37 coupled through the spring 40 to the operational part 35 is operated upward through the spring 40, and the cam member 32 engaged with the arm part 41 formed at the operating part 37 is rotated counterclockwise in FIG. 6. Under the state where the leading end portion of the nose portion 8 is pressed to the work W and the movable sleeve 12 is arranged through the contact member 16 in the top dead center position, the step portion 44 formed on the cam surface 33 of the cam member 32 does not engage with the lock-out bar 31 and the cam member 32 can rotate counterclockwise. Therefore, the operating part 37, while rotating the cam member 32 by the operation of the operational part 35, operates upward, and the projection part 36 formed at the upper end of the operating part 37 turns on the switch 26, whereby the mixed gas in the combustion chamber 6 is ignited by the spark plug and burned, and the piston 4 housed in the cylinder 3 is driven by the combustion gas expanded in the combustion chamber 6.

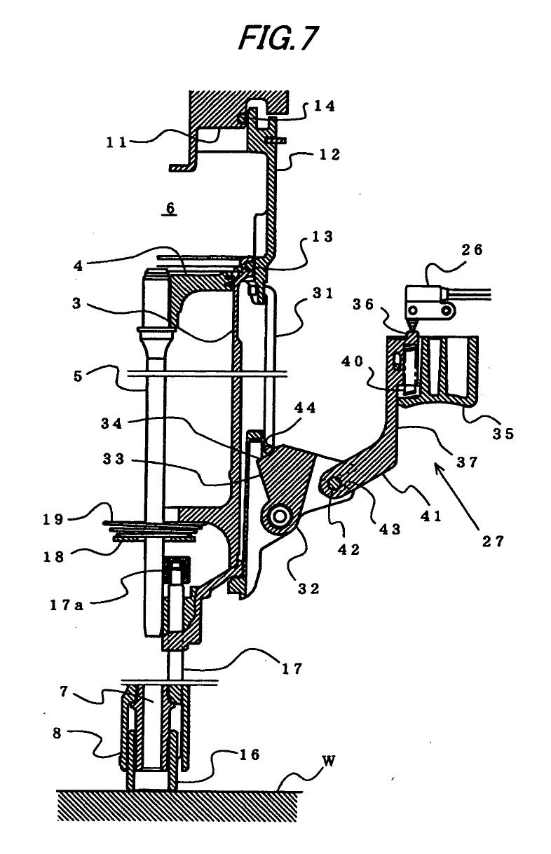

When the operational part 35 of the trigger unit 27 is operated slightly from the state shown in FIG. 5 where the movable sleeve 12 is operated to the up-position by the operation of the contact member 16, the operating part 37 is operated upward by the operation of the operational part 35 as shown in FIG. 7, and the cam member 32 is rotated counterclockwise with the operation of the operating part 37, whereby the cam surface 34 of the cam member 32 is arranged below the lock-out bar 31. Under the state, when the nailing machine 1 is operated upward so that the nose portion 8 is separated from the surface of the work W, the contact member 16 returns downward with the separation of the nose portion 8 from the surface of the work W. With the return of the contact member 16, the movable sleeve 12 attempts to slide downward. However, since the lower end portion of the lock-out bar 31 coupled to the movable sleeve 12 engages with the cam surface 34 of the cam member 31, the more descent of the movable sleeve 12 is interrupted, so that the tightly closed state of the combustion chamber 6 is retained by the movable sleeve 12. In the state, the step portion 44 formed on the cam surface 34 of the cam member 32 engages with the lock-out bar 31 and the rotation of the cam member 32 is interrupted.

In case that the user attempts to rotate the cam member 32 through the operating part 37 by operating the operational part 35 of the trigger unit 27 under the state, since the rotation of the cam member 32 is interrupted by the lock-out bar 31 as described before, the operating part 37 cannot be operated upward, so that the operating part 37 cannot be turn on the switch 26 for applying electric current to the spark plug, whereby poor nail-driving such as protrusion of the nailhead caused by nail-driving in the state where the nose portion 8 is apart from the work, does not arise.

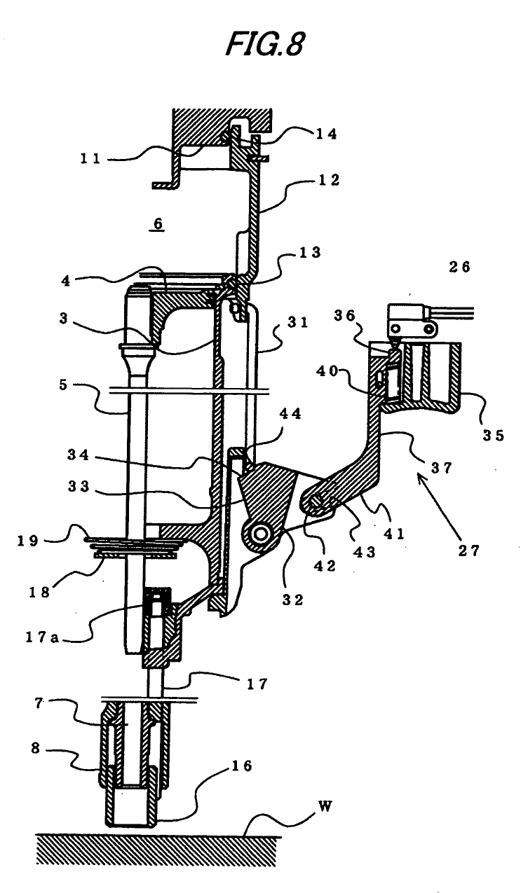

When the operational part 35 of the trigger unit 27 is operated more by the large operation force in the state where the step portion 44 formed on the cam surface 34 of the cam member 32 and the lock-out bar 31 engage with each other as shown in FIG. 7 and the rotation of the cam member 32 is interrupted, the operating part 37 cannot operate as shown in FIG. 8 because the cam member 32 is not rotated, and the spring 49 arranged between the operational part 35 and the operating part 37 yields, whereby displacement of the only operational part 35 is produced, which prevents the operating part 37 and the cam member 32 from receiving the large operation force. Hereby, it is prevented that the operating part 37 is deformed by receiving the large force and turns on the switch 26 by the projection part 36, or that the cam member 32 is forcedly rotated by receiving the large rotation force and turns on the switch 26.

Further, as shown in FIGS. 7 and 8, when the leading end of the discharge port 7 of the nose portion 8 is pressed on the work W under the state where the rotation of the cam member 32 is interrupted, the contact member 16 is pressed and the lock-out bar 31 moves upward again, so that the condition similar to that in FIG. 6 is obtained. When the operation of the operational part 35 is released under the condition, the nailing machine is put into the same condition as that in FIG. 5. When the pressing of the nose portion 8 on the work W is further released, the nailing machine is put into the same condition as that in FIG. 4, and returns to the initial state.

Although the invention has been described in detail or with reference to the specified embodiment, it is believed to be obvious by those skilled in the art that various changes and modifications can be added without departing from the spirit and the scope of the invention.

The application is based on Japanese Patent Application No. 2004-070071 filed on Mar. 12, 2004, the contents of which are incorporated herein by reference.

### INDUSTRIAL APPLICABILITY

According to the combustion gas type nailing machine of the invention, there are provided the lock-out bar of which one end is coupled to the movable sleeve, the cam member which is provided opposed to the other end of the lock-out bar and cooperates with the trigger unit rotatably, and the cam surface which is formed on the cam member and comes into contact with the lower end of the lock-out bar thereby to retain the movable sleeve in the state where the combustion chamber is closed. Therefore, even when the nailing machine operates upward due to the reaction to the nail driving operation and the contact member operates in the return direction, the cum surface engages with the lower end of the lock-out bar, and the movable sleeve forming the combustion chamber is retained in the up-position where the combustion chamber is tightly closed. Hereby, while the piston operated by the combustion gas is returning to the top dead center position, the combustion chamber is not opened, so that the return of the piston can be surely performed.

Further, the step portion which can engage with the lock-out bar is formed on the cam surface. Herein, when the cam surface holds the movable sleeve, the step portion engages with the lock-out bar to interrupt the rotational movement of the cam member, whereby it is prevented that the trigger unit is operated to the position where the trigger unit ignites the inflammable gas. Therefore, in the state where the nose portion or the contact member of the nailing machine is separated from the work and the movable sleeve is retained by the cam member in the state where the combustion chamber is closed, the operating part of the trigger unit cannot be operated more upward. Accordingly, since the operating part cannot turn on the switch for applying the electric current to the spark plug, it is possible to prevent poor nail-driving caused by nail-driving in the state where the nose portion is apart from the work.

Further, the trigger unit includes the operating part formed at the cam member, and the operational part which is coupled through the elastic member to the operating part and manually operated, and the operating part has the projection part which operates the switch for igniting the inflammable gas generated inside the combustion chamber. Therefore, in case that the operational part is operated by the large force under the state where the movable sleeve is retained by the cam member in the state where the combustion chamber is closed, the elastic member arranged between the operational part and the operating part yields, which prevents the operating part and the cam member for receiving the large force. Hereby, it is possible to prevent that the operating part is deformed by receiving the large force thereby to turn on the switch by the projection part and the inflammable gas in the combustion chamber is ignited, or that the cam member is forcedly rotated by receiving the large rotation force thereby to turn on the switch.

1. A combustion gas type nailing machine comprising:
a cylinder arranged in a housing;
a piston slidably accommodated in the cylinder and formed with a driver for driving a nail at one end of the piston;
a nose portion attached to one end side of the housing and formed with a discharge port for slidably guiding the driver;
a combustion chamber formed above the cylinder in the housing and formed by a movable sleeve which is slidable up and down;
a contact member that is arranged protrusively in a leading end direction of the nose portion and operates the movable sleeve to close the combustion chamber when the contact member is engaged with a work;
a trigger unit that is manually operable to ignite inflammable gas generated in the combustion chamber, wherein the inflammable gas burns in the closed combustion chamber to generate combustion gas when the trigger unit is operated, and the piston is driven by the generated combustion gas to drive a nail;
a lock-out bar, one end of the lock-out bar being coupled to the movable sleeve;
a cam member that is opposed to the other end of the lock-out bar and rotatable by interlocking with the trigger unit;
a cam surface formed on the cam member and capable of being contact with the lower end of the lock-out bar so as to retain the movable sleeve in a state where the combustion chamber is closed; and
a step portion formed on the cam surface and capable of engaging with the lock-out bar,
when the cam surface retains the movable sleeve, the step portion engages with the lock-out bar to interrupt a rotational movement of the cam member and to prevent the trigger unit from being operated a position where the trigger unit ignites the inflammable gas.

2. The combustion gas type nailing machine according to claim 1, wherein the trigger unit includes an operating part formed at the cam member, and an operational part coupled through an elastic member to the operating part and manually operated; and
the operating part includes a projection part that operates a switch for igniting the inflammable gas generated in the combustion chamber.
